(19) United States
(12) Patent Application Publication
(10) Pub. No.: US 2021/0245577 A1
(43) Pub. Date: Aug. 12, 2021

(54) VEHICLE AIR CONDITIONING APPARATUS

(71) Applicant: SANDEN AUTOMOTIVE CLIMATE SYSTEMS CORPORATION, Isesaki-shi, Gunma (JP)

(72) Inventor: Ryo MIYAKOSHI, Isesaki-shi, Gunma (JP)

(73) Assignee: SANDEN AUTOMOTIVE CLIMATE SYSTEMS CORPORATION, Isesaki-shi, Gunma (JP)

(21) Appl. No.: 16/973,009

(22) PCT Filed: Jun. 7, 2019
(86) PCT No.: PCT/JP2019/022658

§ 371 Date: Dec. 7, 2020

(30) Foreign Application Priority Data
Jun. 27, 2018 (JP) 2018-122154

(51) Int. Cl. B60H 1/00; B60H 1/22

(52) U.S. Cl. CPC B60H 1/00921; F25B 1/00; B60H 1/22

(57) ABSTRACT

There is provided a vehicle air conditioning apparatus capable of removing frost formed on an outdoor heat exchanger at the same time as cooling of a battery. The vehicle air conditioning apparatus performs the operation in a first battery cooling mode, a second battery cooling mode, or a solo battery cooling mode, when it is determined that the battery needs to be cooled and also determined that the frost formed on the outdoor heat exchanger needs to be removed. By this means, it is possible to cool the battery and melt the frost formed on the outdoor heat exchanger at the same time by the battery cooling operation, and therefore it is possible to reduce the power consumption compared to the case where the battery cooling operation and the defrosting operation are performed individually.

### TECHNICAL FIELD

The present invention relates to a vehicle air conditioning apparatus applicable to a vehicle such as an electric car and a hybrid car, which is equipped with a battery for supplying electric power to an electric motor to drive the vehicle.

### BACKGROUND ART

Conventionally, this sort of vehicle air conditioning apparatus includes a refrigerant circuit including a compressor, an indoor heat exchanger, an outdoor heat exchanger, and expansion valves, and is configured to cool, heat, and dehumidify a vehicle compartment by supplying the vehicle compartment with the air having been subjected to a heat exchange with the refrigerant in the indoor heat exchanger.

In addition, there has been known a vehicle equipped with this vehicle air conditioning apparatus, such as an electric car and a hybrid car, which includes a traction battery for supplying electric power to an electric motor as a drive source. When the vehicle is continuously driven or when the traction battery is quickly charged, the traction battery may release heat to increase the temperature.

Therefore, in order to cool the traction battery, the vehicle includes a cooling water circuit to which the traction battery is connected, and the cooling water circuit is connected to a refrigerant circuit via a water-refrigerant heat exchanger (see, for example, Patent Literature 1). The vehicle performs a battery cooling operation where cooling water flowing through the cooling water circuit is used to cool the traction battery, and the cooling water having cooled the traction battery and therefore absorbed the heat is subjected to a heat exchange with a refrigerant flowing through the refrigerant circuit.

### CITATION LIST

### Patent Literature

PTL1: Japanese Patent Application Laid-Open No. 2018-43741

### SUMMARY OF INVENTION

### Technical Problem

In a case where the vehicle air conditioning apparatus performs a heating operation to heat a vehicle compartment when the vehicle is driven under the condition of a low temperature of the outdoor air, frost may be formed on an outdoor heat exchanger. When the frost is formed on the outdoor heat exchanger, the vehicle air conditioning apparatus may perform a defrosting operation to melt the frost on the outdoor heat exchanger by flowing the high-temperature and pressure refrigerant discharged from a compressor into the outdoor heat exchanger.

Here, the vehicle air conditioning apparatus cannot perform the heating operation to heat the vehicle compartment at the same time the defrosting operation is performed, and therefore the defrosting operation is performed while a key switch is turned off, that is, the vehicle is not driven. Also, during the charge of the battery, the battery cooling operation is performed while the vehicle is stopped.

Therefore, the vehicle air conditioning apparatus needs to perform the battery cooling operation during the defrosting operation.

It is therefore an object of the invention to provide a vehicle air conditioning apparatus capable of removing the frost formed on the outdoor heat exchanger at the same time as the cooling of the battery.

### Solution to Problem

To achieve the object, the present invention provides a vehicle air conditioning apparatus with a battery cooling function to cool a battery for supplying electronic power to an electric motor for driving a vehicle including: a compressor configured to compress a refrigerant; a battery cooling heat absorbing unit configured to absorb heat released from the battery; an outdoor heat exchanger configured to perform a heat exchange between the refrigerant and air outside a vehicle compartment; a battery cooling circuit configured to release the heat from the refrigerant discharged from the compressor in the outdoor heat exchanger, and absorb the heat into the refrigerant in the battery cooling heat absorbing unit; a defrosting circuit configured to release the heat from the refrigerant discharged from the compressor in the outdoor heat exchanger, and cause the refrigerant flowing out of the outdoor heat exchanger to be sucked into the compressor; a battery cooling determination unit configured to determine whether the battery needs to be cooled; a defrosting determination unit configured to determine whether frost formed on the outdoor heat exchanger needs to be removed; and a circuit setting unit configured to flow the refrigerant discharged from the compressor through the battery cooling circuit, when the battery cooling determination unit determines that the battery needs to be cooled, and the defrosting determination unit determines that the frost formed on the outdoor heat exchanger needs to be removed.

In this way, the battery cooling circuit is set to allow the outdoor heat exchanger to function as a heat releasing unit in which the heat is released from the refrigerant. Therefore, it is possible to melt the frost on the outdoor heat exchanger at the same time as the cooling of the battery.

### Advantageous Effect

According to the invention, the battery cooling circuit is set to allow the frost formed on the outdoor heat exchanger to be melted at the same time as the cooling of the battery. Therefore, it is possible to reduce the power consumption compared to a case where the battery cooling operation and the defrosting operation are performed individually.

### BRIEF DESCRIPTION OF DRAWINGS

FIG. 1 schematically illustrates the configuration of a vehicle air conditioning apparatus according to an embodiment of the invention;

FIG. 2 is a block diagram illustrating a control system;

FIG. 3 schematically illustrates the configuration of the vehicle air conditioning apparatus solely performing a battery cooling operation;

FIG. 4 schematically illustrates the configuration of the vehicle air conditioning apparatus performing an air conditioning operation and the battery cooling operation at the same time;

FIG. 5 schematically illustrates the configuration of the vehicle air conditioning apparatus performing a defrosting operation;

FIG. 6 is a flowchart illustrating an operation switching control process; and

FIG. 7 is a flowchart illustrating the operation switching control process.

### DESCRIPTION OF EMBODIMENTS

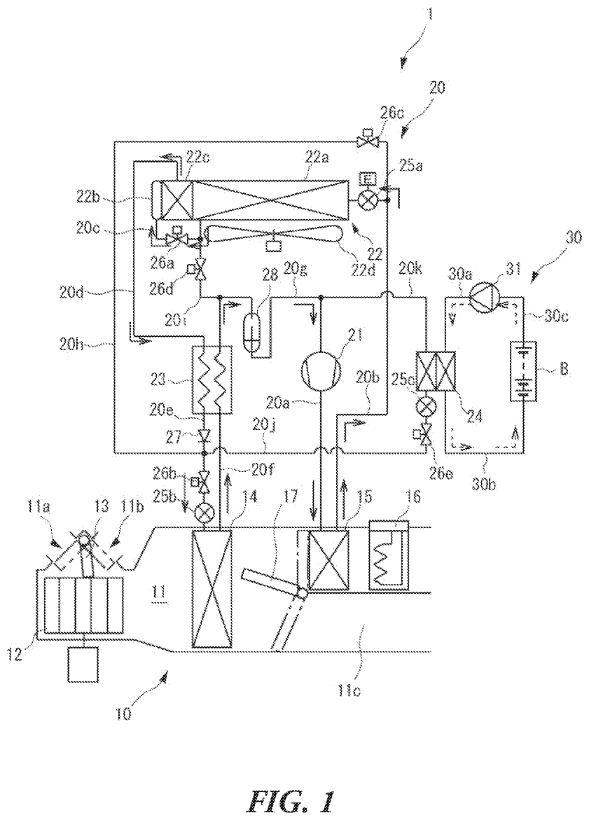

FIGS. 1 to 7 illustrate an embodiment of the invention.

A vehicle air conditioning apparatus 1 according to the invention is applicable to a vehicle such as an electric car and a hybrid car, which can be driven by the driving force of an electric motor.

The vehicle includes an electric motor for driving the vehicle, and a battery B configured to accumulate electric power to be supplied to the electric motor.

The battery B releases the heat when the battery B supplies electric power to the electric motor during the driving of the vehicle, and is charged. The battery B can be quickly charged for a short time by increasing one or both of the voltage and the current of the supplied electric power, and during this quick charge, the amount of the heat released from the battery B particularly increases. It is preferred that the battery B is used at a temperature within the range of 10 to 30 degrees Celsius, and when the temperature is equal to or higher than 50 degree Celsius, the deterioration of the battery B may accelerate. Therefore, the battery B is required to be cooled according to need, and to be maintained at a temperature lower than a desired temperature T1, for example, 50 degrees Celsius.

This vehicle air conditioning apparatus 1 has a battery cooling function to cool the battery B. As illustrated in FIG. 1, the vehicle air conditioning apparatus 1 includes: an air conditioning unit 10 provided in the vehicle compartment of the vehicle; a refrigerant circuit 20 provided across the vehicle compartment and the outside of the vehicle compartment; and a heat medium circuit 30 configured to allow a heat medium that absorbs the heat released from the battery B to flow therethrough.

The air conditioning unit 10 includes an air flow passage 11 that allows the air supplied to the vehicle compartment to flow therethrough. An outdoor air inlet 11a and an indoor air inlet 11b are provided in one end side of the air flow passage 11. The outdoor air inlet 11a is configured to allow the air outside the vehicle compartment to flow into the air flow passage 11, and the indoor air inlet 11b is configured to allow the air in the vehicle compartment to flow into the air flow passage 11. Meanwhile, a foot outlet, a vent outlet and a defroster outlet (not shown) are provided in the other end side of the air flow passage 11. The foot outlet is configured to allow the air flowing through the air flow passage 11 to blow to the feet of the passengers. The vent outlet is configured to allow the air flowing through the air flow passage 11 to blow to the upper bodies of the passengers. The defroster outlet is configured to allow the air flowing through the air flow passage 11 to blow to the surface of the front window in the vehicle compartment.

An indoor blower 12 such as a sirocco fan is provided in the one end side of the air flow passage 11 and configured to allow the air to flow through the air flow passage 11 from the one end side to the other end side.

Also, an inlet switching damper 13 is provided in the one end side of the air flow passage 11 and configured to be able to open one of the outdoor air inlet 11a and the indoor air inlet 11b and close the other. The inlet switching damper 13 can switch the mode of the inlets among: an outdoor air supply mode to close the indoor air inlet 11b and open the outdoor air inlet 11a; an indoor air circulating mode to close the outdoor air inlet 11a and open the indoor air inlet 11b; and an indoor and outdoor air suction mode to open both the outdoor air inlet 11a and the indoor air inlet 11b by disposing the inlet switching damper 13 between the outdoor air inlet 11a and the indoor air inlet 11b.

A heat absorbing unit 14 is provided downstream of the indoor blower 12 in the air flow direction of the air flow passage 11. The heat absorbing unit 14, as an indoor heat exchanger, is configured to cool and dehumidify the air flowing through the air flow passage 11. In addition, a heat releasing unit 15 is provided downstream of the heat absorbing unit 14 in the air flow direction of the air flow passage 11. The heat releasing unit 15, as an indoor heat exchanger, is configured to heat the air flowing through the air flow passage 11.

The heat releasing unit 15 is disposed in one side of the orthogonal direction of the air flow passage 11, and a heat releasing unit bypass flow passage 11c is formed in the other side of the orthogonal direction of the air flow passage 11 to bypass the heat releasing unit 15. An air heater 16 is provided downstream of the heat releasing unit 15 in the air flow direction of the air flow passage 11 and configured to heat the air to be supplied to the vehicle compartment.

An air mix damper 17 is provided in the air flow passage 11 between the heat absorbing unit 14 and the heat releasing unit 15, and configured to control the percentage of the air to be heated by the heat releasing unit 15, which has passed through the heat absorbing unit 14. The air mix damper 17 is provided upstream of the heat releasing unit 15 and the heat releasing unit bypass flow passage 11c in the air flow direction, and configured to close the upstream side of one of the heat releasing unit bypass flow passage 11c and the heat releasing unit 15 and open the other in the air flow direction, or open both the heat releasing unit bypass flow passage 11c and the heat releasing unit 15 to adjust the degree of opening of the upstream side of the heat releasing unit 15 in the air flow direction. The degree of opening of the air mix damper 17 is 0% when the upstream side of the heat releasing unit 15 in the air flow direction of the air flow passage 11 is closed and the heat releasing unit bypass flow passage 11c is open. On the other hand, the degree of opening of the air mix damper 17 is 100% when the upstream side of the heat releasing unit 15 in the air flow direction of the air flow passage 11 is open and the heat releasing unit bypass flow passage 11c is closed.

The refrigerant circuit 20 includes: the heat absorbing unit 14; the heat releasing unit 15; a compressor 21 configured to compress a refrigerant; the outdoor heat exchanger 22 configured to perform a heat exchange between the refrigerant and the air outside the vehicle compartment; an internal heat exchanger 23 configured to perform a heat exchange between the refrigerant flowing into the heat absorbing unit 14 and the refrigerant flowing out of the heat absorbing unit 14; a heat medium heat exchanger 24 as a battery cooling heat absorbing unit configured to perform a heat exchange between the refrigerant flowing through the refrigerant circuit 20 and the heat medium flowing through the heat medium circuit 30; a first electronic expansion valve 25a having a degree of opening which can be adjusted from the full close to the full open; second and third mechanical expansion valves 25b and 25c having degrees of opening which are adjusted according to a change in the temperature of the refrigerant at the outlets of the heat absorbing unit 14 and the heat medium heat exchanger 24; first to fifth solenoid valves 26a, 26b, 26c, 26d, and 26e as flow passage opening and closing valves configured to open and close the refrigerant flow passage; a check valve 27 configured to control the flow direction of the refrigerant in the refrigerant flow passage; and an accumulator 28 configured to separate between gaseous refrigerant and liquid refrigerant to prevent the liquid refrigerant from being sucked into the compressor 21. These components are connected by, for example, an aluminum pipe or a copper pipe. As the refrigerant flowing through the refrigerant circuit 20, for example, R-134a may be used.

The outdoor heat exchanger 22 is disposed out of the vehicle compartment, for example, in an engine room, such that the air subjected to a heat exchange with the refrigerant flows through the outdoor heat exchanger 22 in the front-to-back direction of the vehicle. An outdoor blower 22d is provided in the vicinity of the outdoor heat exchanger 22 to flow the air outside the vehicle compartment in the front-to-back direction when the vehicle is stopped. The outdoor heat exchanger 22 includes: a main body 22a configured to release the heat from the refrigerant or absorb the heat into the refrigerant; a receiver 22b configured to receive the refrigerant having released the heat and separate the gaseous refrigerant from the liquid refrigerant; and a supercooling unit 22c configured to supercool the liquid refrigerant flowing out of the receiver 22b.

To be more specific about the configuration of the refrigerant circuit 20, the input side of the heat releasing unit 15 into which the refrigerant flows is connected to the delivery side of the compressor 21 from which the refrigerant is discharged, thereby to form a refrigerant flow passage 20a. Meanwhile, the input side of the outdoor heat exchanger 22 into which the refrigerant flows is connected to the output side of the heat releasing unit 15 from which the refrigerant is discharged, thereby to form a refrigerant flow passage 20b. The first expansion valve 25a is provided in the refrigerant flow passage 20b. The input side of the receiver 22b into which the refrigerant flows is connected to the output side of the main body 22a of the outdoor heat exchanger 22 from which the refrigerant is discharged, thereby to form a refrigerant flow passage 20c. The first solenoid valve 26a is provided in the refrigerant flow passage 20c. Meanwhile, the input side of the supercooling unit 22c into which the refrigerant flows is connected to the output side of the receiver 22b of the outdoor heat exchanger 22 from which the refrigerant is discharged. The input side of the internal heat exchanger 23 into which a high-pressure refrigerant flows is connected to the output side of the supercooling unit 22c from which the refrigerant is discharged, thereby to form a refrigerant flow passage 20d. The input side of the heat absorbing unit 14 into which the refrigerant flows is connected to the output side of the internal heat exchanger 23 from which the high-pressure refrigerant is discharged, thereby to form a refrigerant flow passage 20e. The check valve 27, the second solenoid valve 26b, and the second expansion valve 25b are provided in the refrigerant flow passage 20e in the order from the internal heat exchanger 23 side. The input side of the internal heat exchanger 23 into which a low-pressure refrigerant flows is connected to the output side of the heat absorbing unit 14 from which the refrigerant is discharged, thereby to form a refrigerant flow passage 20f. The suction side of the compressor 21 into which the refrigerant is sucked is connected to the output side of the internal heat exchanger 23 from which the low-pressure refrigerant is discharged, thereby to form a refrigerant flow passage 20g. The accumulator 28 is provided in the refrigerant flow passage 20g. A refrigerant flow passage 20h is formed between the heat releasing unit 15 and the first expansion valve 25a in the refrigerant flow passage 20b, and is formed by being connected to a portion of the refrigerant flow passage 20e between the check valve 27 and the second solenoid valve 26b, bypassing the outdoor heat exchanger 22. The third solenoid valve 26c is provided in the refrigerant flow passage 20h. A refrigerant flow passage 20i is formed between the main body 22a of the outdoor heat exchanger 22 and the first solenoid valve 26a in the refrigerant flow passage 20c and is formed by being connected to a portion between the internal heat exchanger 23 and the accumulator 28 in the refrigerant flow passage 20g. The forth solenoid valve 26d is provided in the refrigerant flow passage 20i. In addition, a refrigerant flow passage 20j is formed between the check valve 27 and the second solenoid valve 26b in the refrigerant flow passage 20e and is formed by being connected to the input side of the heat medium heat exchanger 24 into which the refrigerant flows. The fifth solenoid valve 26e and the third expansion valve 25c are provided in the refrigerant flow passage 20j in the order from the refrigerant flow passage 20e side. A refrigerant flow passage 20k is formed on the output side of the heat medium heat exchanger 24 from which the refrigerant is discharged by being connected to a portion between the accumulator 28 and the suction side of the compressor 21 into which the refrigerant is sucked in the refrigerant flow passage 20g.

The heat medium circuit 30 includes the heat medium heat exchanger 24, a heat medium pump 31 configured to pump the heat medium, and the battery B which are connected by, for example, an aluminum pipe or a copper pipe. As the heat medium flowing through the heat medium circuit 30, antifreeze solution, for example, ethyleneglycol may be used.

To be more specific, the input side of the heat medium heat exchanger 24 into which the heat medium flows is connected to the delivery side of the heat medium pump 31 from which the heat medium is discharged, thereby to form a heat medium flow passage 30a. The input side of the battery B into which the heat medium flows is connected to the output side of the heat medium heat exchanger 24 from which the heat medium is discharged, thereby to form a heat medium flow passage 30b. The suction side of the heat medium pump 31 into which the heat medium is sucked is connected to the output side of the battery B from which the heat medium is discharged, thereby to form a heat medium flow passage 30c.

Moreover, the vehicle air conditioning apparatus 1 includes a controller 40 configured to control the temperature and the humidity of the vehicle compartment at a set temperature and a set humidity, and control the temperature of the battery B at a value equal to or lower than a predetermined temperature.

The controller 40 includes a CPU, a ROM, and a RAM. When the controller 40 receives an input signal from a device connected to the input side, the CPU reads a program stored in the ROM based on the input signal, stores the state detected through the input signal in the RAM, and sends an output signal to a device connected to the output side.

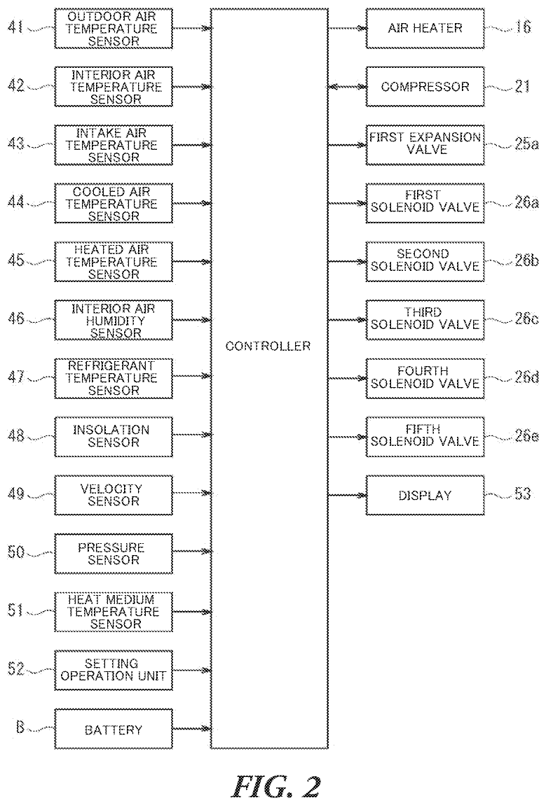

As illustrated in FIG. 2, the compressor 21; an outdoor air temperature sensor 41 configured to detect a temperature Tam of the air outside the vehicle compartment; an interior air temperature sensor 42 configured to detect a temperature Tr of the air of the vehicle compartment; an intake air temperature sensor 43 configured to detect a temperature Ti of the air flowing into the air flow passage 11; a cooled air temperature sensor 44 configured to detect a temperature Te of the air having been cooled in the heat absorbing unit 14; a heated air temperature sensor 45 configured to detect a temperature Tc of the air having been heated in the heat releasing unit 15; an interior air humidity sensor 46 configured to detect a humidity Rh in the vehicle compartment; a refrigerant temperature sensor 47 configured to detect a temperature Thex of the refrigerant after a heat exchange in the outdoor heat exchanger 22; an insolation sensor 48 configured to detect an amount of insolation Ts, which is a kind of photo sensor; a velocity sensor 49 configured to detect a velocity V of the vehicle; a pressure sensor 50 configured to detect a pressure Pd of the high pressure side of the refrigerant circuit 20; a heat medium temperature sensor 51 configured to detect the temperature of the heat medium flowing out of the heat medium heat exchanger 24 in the heat medium circuit 30; a setting operation unit 52 operated by a passenger to set a setting temperature Tset of the vehicle compartment, and to set the switching of the operation for the air conditioning; and the battery B are connected to the input side of the controller 40.

Meanwhile, as illustrated in FIG. 2, the air heater 16, the compressor 21, the first expansion valve 25a, the first to fifth solenoid valves 26a, 26b, 26c, 26d, and 26e, and a display 53, for example, a liquid crystal display as an information unit configured to provide information about the temperature of the vehicle compartment and the operation state are connected to the output side of the controller 40.

The vehicle air conditioning apparatus 1 with the above-described configuration adjusts the temperature and the humidity of the air in the vehicle compartment, by using the air conditioning unit 10 and the refrigerant circuit 20. To be more specific, the vehicle air conditioning apparatus 1 performs a cooling operation to reduce the temperature of the vehicle compartment; a cooling and dehumidifying operation to reduce the humidity and the temperature of the vehicle compartment; a heating operation to increase the temperature of the vehicle compartment; and a heating and dehumidifying operation to reduce the humidity and increase the temperature of the vehicle compartment.

For example, when the cooling operation is performed, the indoor blower 12 is actuated and the degree of opening of the air mix damper 17 is set to 0% in the air conditioning unit 10. In addition, the compressor 21 is actuated while the first expansion valve 25a is fully open, the first and second solenoid valves 26a and 26b are open, and the third to firth solenoid valves 26c, 26d, and 26e are closed in the refrigerant circuit 20. Moreover, the heat medium pump 31 is actuated in the heat medium circuit 30.

By this means, as indicated by solid arrows in FIG. 1, the refrigerant discharged from the compressor 21 flows through the refrigerant circuit 20 in the order of the refrigerant flow passage 20a, the heat releasing unit 15, the refrigerant flow passage 20b, the main body 22a of the outdoor heat exchanger 22, the refrigerant flow passage 20c, the receiver 22b, the supercooling unit 22c, the refrigerant flow passage 22d, the high-pressure side of the internal heat exchanger 23, the refrigerant flow passage 22e, the heat absorbing unit 14, the refrigerant flow passage 20f, the low-pressure side of the internal heat exchanger 23, and the refrigerant flow passage 20g, and is sucked into the compressor 21.

Meanwhile, as indicated by dashed arrows in FIG. 1, the heat medium discharged from the heat medium pump 31 flows through in the order of the heat medium flow passage 30a, the heat medium heat exchanger 24, the heat medium flow passage 30b, the battery B, and the heat medium flow passage 30c, and is sucked into the heat medium pump 31 in the heat medium circuit 30.

The refrigerant flowing through the refrigerant circuit 20 does not release the heat in the heat releasing unit 15 because the degree of opening of the air mix damper 17 is 0%, but releases the heat in the outdoor heat exchanger 22 and absorbs the heat in the heat absorbing unit 14.

The air flowing through the air flow passage 11 is subjected to a heat exchange with the refrigerant absorbing the heat in the heat absorbing unit 14, and therefore is cooled to a target air-blowing temperature TAO, and then blows to the vehicle compartment.

Meanwhile, the heat medium flowing through the heat medium circuit 30 is not subjected to a heat exchange with the refrigerant in the heat medium heat exchanger 24, but is heated in the battery B by the heat released from the battery B.

In addition, for example, during the cooling and dehumidifying operation to reduce the temperature and the humidity of the vehicle compartment, the degree of opening of the air mix damper 17 of the air conditioning unit 10 is set to a value greater than 0% in the refrigerant flow passage in the refrigerant circuit 20 for the cooling operation.

By this means, the refrigerant flowing through the refrigerant circuit 20 releases the heat in the heat releasing unit 15 and the outdoor heat exchanger 22, and absorbs the heat in the heat absorbing unit 14.

The air flowing through the air flow passage 11 is dehumidified and cooled by the heat exchange with the refrigerant absorbing the heat in the heat absorbing unit 14, and heated to the target air-blowing temperature TAO in the heat releasing unit 15, and then blows to the vehicle compartment.

Moreover, during the heating and dehumidifying operation to reduce the humidity and increase the temperature of the vehicle compartment, the degree of opening of the first expansion valve 25a is set to a predetermined value smaller than the full open in the refrigerant flow passage in the refrigerant circuit 20 for the cooling operation. In addition, the degree of opening of the air mix damper 17 of the air conditioning unit 10 is set to a value greater than 0%.

By this means, the refrigerant flowing through the refrigerant circuit 20 releases the heat in the heat releasing unit 15, and absorbs the heat in the outdoor heat exchanger 22 and the heat absorbing unit 14.

The air flowing through the air flow passage 11 of the air conditioning unit 10 is dehumidified and cooled by the heat exchange with the refrigerant absorbing the heat in the heat absorbing unit 14, and heated to the target air-blowing temperature TAO in the heat releasing unit 15, and then blows out.

In addition, the vehicle air conditioning apparatus 1 performs the battery cooling operation to cool the battery B by using the refrigerant circuit 20 and the heat medium circuit 30.

When the battery cooling operation is solely performed without adjusting the temperature and the humidity of the vehicle compartment, the indoor blower 12 is stopped and the degree of opening of the air mix damper 17 is set to 0% in the air conditioning unit 10. In addition, the compressor 21 is actuated while the first expansion valve 25a is fully open, the first and fifth solenoid valves 26a and 26e are open, and the second to fourth solenoid valves 26b, 26c, and 26d are closed in the refrigerant circuit 20. Moreover, the heat medium pump 31 is actuated in the heat medium circuit 30.

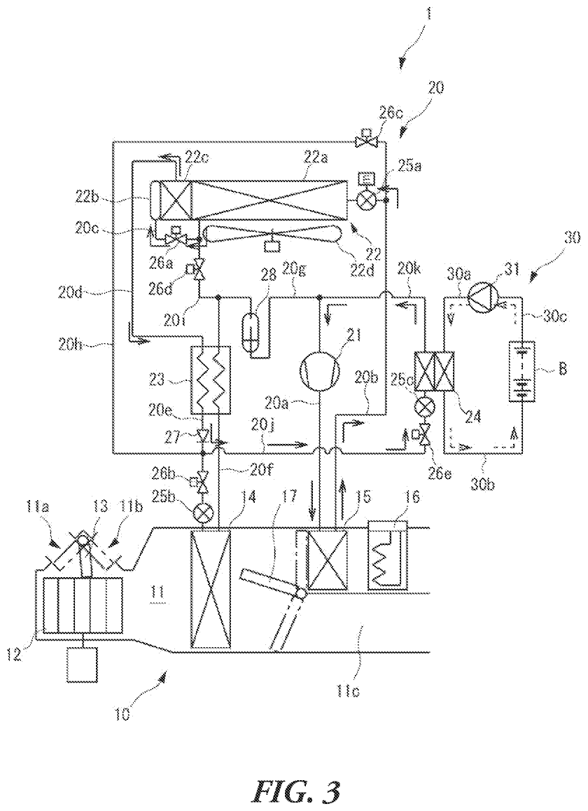

By this means, the refrigerant discharged from the compressor 21 flows through the refrigerant circuit 20 in the order of the refrigerant flow passage 20a, the heat releasing unit 15, the refrigerant flow passage 20b, the main body 22a of the outdoor heat exchanger 22, the refrigerant flow passage 20c, the receiver 22b, the supercooling unit 22c, the refrigerant flow passage 22d, the high-pressure side of the internal heat exchanger 23, the refrigerant flow passages 22e and 20j, the heat medium heat exchanger 24, and the refrigerant flow passages 20k and 20g and is sucked into the compressor 21, as a battery cooling circuit indicated by solid arrows in FIG. 3.

Meanwhile, as indicated by dashed arrows in FIG. 3, the heat medium discharged from the heat medium pump 31 flows through in the order of the heat medium flow passage 30a, the heat medium heat exchanger 24, the heat medium flow passage 30b, the battery B, and the heat medium flow passage 30c, and is sucked into the heat medium pump 31 in the heat medium circuit 30.

The refrigerant flowing through the refrigerant circuit 20 does not release the heat in the heat releasing unit 15 because the indoor blower 12 is stopped and the degree of opening of the air mix damper 17 is 0%, but releases the heat in the outdoor heat exchanger 22 and absorbs the heat in the heat medium heat exchanger 24.

Meanwhile, the heat medium flowing through the heat medium circuit 30 is subjected to a heat exchange with the refrigerant absorbing the heat in the heat medium heat exchanger 24, and therefore is cooled, and then is heated in the battery B by the heat released from the battery B.

The battery B is cooled by the heat medium having been cooled in the heat medium heat exchanger 24.

In addition, when the battery cooling operation is performed at the same time the cooling operation is performed, the indoor blower 12 is actuated and the degree of opening of the air mix damper 17 is set to 0% in the air conditioning unit 10. In addition, the compressor 21 is actuated while the first expansion valve 25a is fully open, the first and second solenoid valves 26a and 26b are open, the third and fourth solenoid valves 26c and 26d are closed, and the fifth solenoid valve 26e is open in the refrigerant circuit 20. Moreover, the heat medium pump 31 is actuated in the heat medium circuit 30.

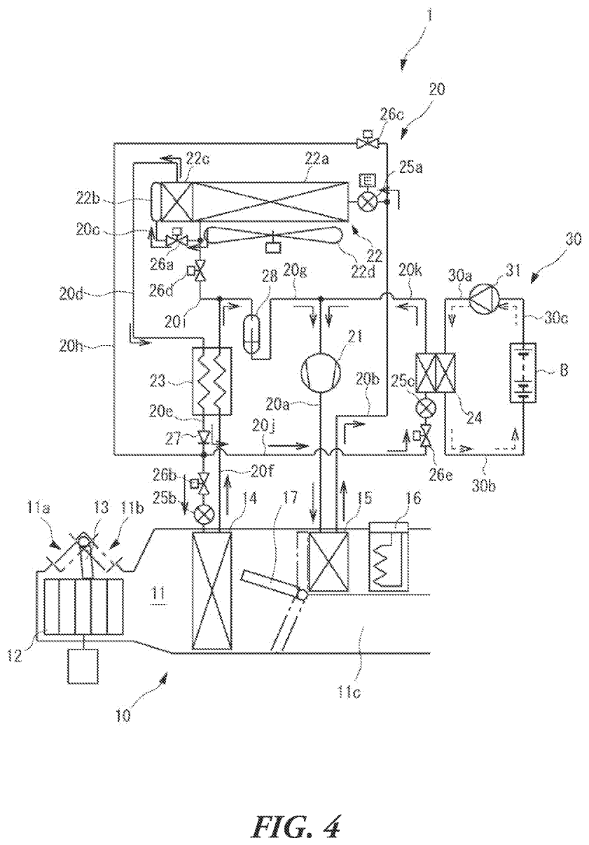

By this means, the refrigerant discharged from the compressor 21 flows through the refrigerant circuit 20 in the order of the refrigerant flow passage 20a, the heat releasing unit 15, the refrigerant flow passage 20b, the main body 22a of the outdoor heat exchanger 22, the refrigerant flow passage 20c, the receiver 22b, the supercooling unit 22c, the refrigerant flow passage 22d, the high-pressure side of the internal heat exchanger 23, and the refrigerant flow passage 22e as a battery cooling circuit indicated by solid arrows in FIG. 4. Part of the refrigerant flowing through the refrigerant flow passage 22e flows through in the order of the heat absorbing unit 14, the refrigerant flow passage 20f, the low-pressure side of the internal heat exchanger 23, and the refrigerant flow passage 20g, and is sucked into the compressor 21. The remaining refrigerant flowing through the refrigerant flow passage 22e flows through in the order of the refrigerant flow passage 20j, the heat medium heat exchanger 24, and the refrigerant flow passages 20k and 20g, and is sucked into the compressor 21.

Meanwhile, as indicated by dashed arrows in FIG. 4, the heat medium discharged from the heat medium pump 31 flows through the heat medium circuit 30 in the order of the heat medium flow passage 30a, the heat medium heat exchanger 24, the heat medium flow passage 30b, the battery B, and the heat medium flow passage 30c, and is sucked into the heat medium pump 31.

The refrigerant flowing through the refrigerant circuit 20 does not release the heat in the heat releasing unit 15 because the degree of opening of the air mix damper 17 is 0%, but releases the heat in the outdoor heat exchanger 22 and absorbs the heat in the heat absorbing unit 14 and the heat medium heat exchanger 24.

The air flowing through the air flow passage 11 is subjected to a heat exchange with the refrigerant absorbing the heat in the heat absorbing unit 14, and therefore is cooled to the target air-blowing temperature TAO, and then blows to the vehicle compartment.

Meanwhile, the heat medium flowing through the heat medium circuit 30 is subjected to a heat exchange with the refrigerant absorbing the heat in the heat medium heat exchanger 24, and therefore is cooled, and then is heated in the battery B by the heat released from the battery B.

The battery B is cooled by the heat medium having been cooled in the heat medium heat exchanger 24.

When frost is formed on the outdoor heat exchanger 22, the defrosting operation is performed to remove the frost on the outdoor heat exchanger 22. When the defrosting operation is performed, the outdoor blower 12 is stopped, and the degree of opening of the air mix damper 17 is set to 0% in the air conditioning unit 10. In addition, the compressor 21 is actuated while the first expansion valve 25a is fully open, the fourth solenoid valve 26d is open, and the first to third, and fifth solenoid valves 26a, 26b, 26c and 26e are closed in the refrigerant circuit 20. Moreover, the heat medium pump 31 is actuated in the heat medium circuit 30.

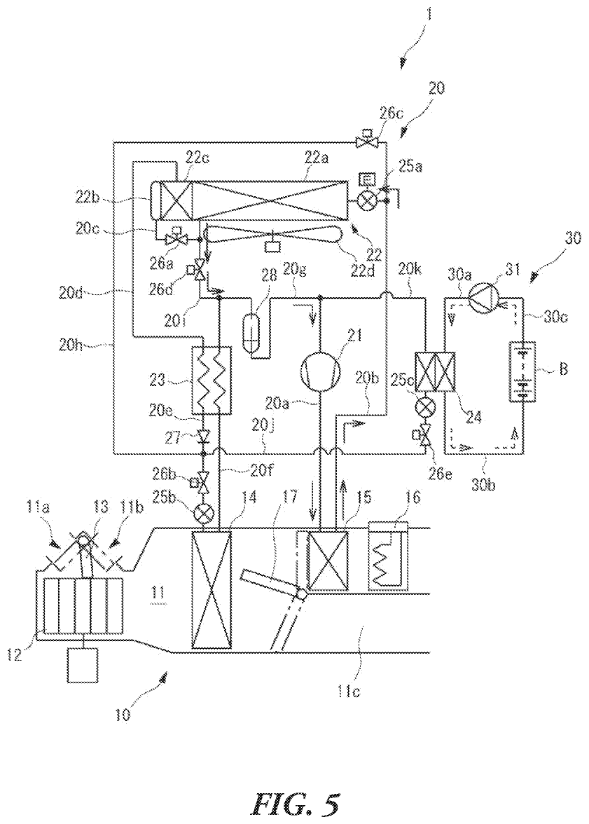

By this means, the refrigerant discharged from the compressor 21 flows through the refrigerant circuit 20 in the order of the refrigerant flow passage 20a, the heat releasing unit 15, the refrigerant flow passage 20b, the main body 22a of the outdoor heat exchanger 22, and the refrigerant flow passages 20c, 20i and 20g, and is sucked into the compressor 21, as a defrosting circuit indicated by solid arrows in FIG. 5.

Meanwhile, as indicated by dashed arrows in FIG. 5, the heat medium discharged from the heat medium pump 31 flows through the heat medium circuit 30 in the order of the heat medium flow passage 30a, the heat medium heat exchanger 24, the heat medium flow passage 30b, the battery B, and the heat medium flow passage 30c, and is sucked into the heat medium pump 31.

The refrigerant flowing through the refrigerant circuit 20 does not release the heat in the heat releasing unit 15 because the indoor blower 12 is stopped and the degree of opening of the air mix damper 17 is 0%, but releases the heat in the outdoor heat exchanger 22.

The frost formed on the outdoor heat exchanger 22 is melted by the heat released from the refrigerant in the outdoor heat exchanger 22.

Meanwhile, the heat medium flowing through the heat medium circuit 30 is not subjected to a heat exchange with the refrigerant in the heat medium heat exchanger 24, but is heated in the battery B by the heat released from the battery B.

Here, in a case where the battery cooling operation is performed at the same time the cooling operation or the cooling and dehumidifying operation is performed, when the heat is absorbed into the refrigerant in the heat absorbing unit 14 and the heat medium heat exchanger 24 at the same time, the outdoor heat exchanger 22 functions as a heat releasing unit to surely release the heat from the refrigerant.

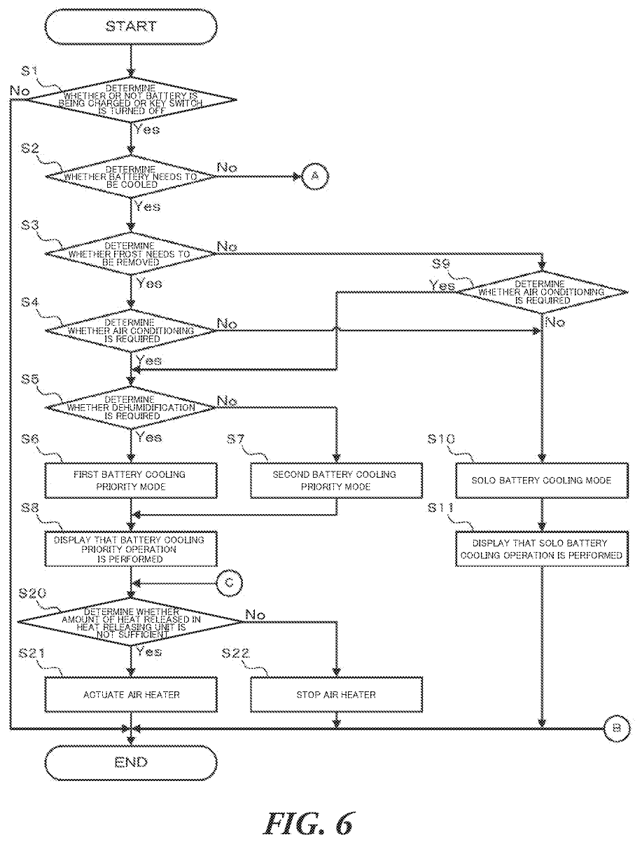

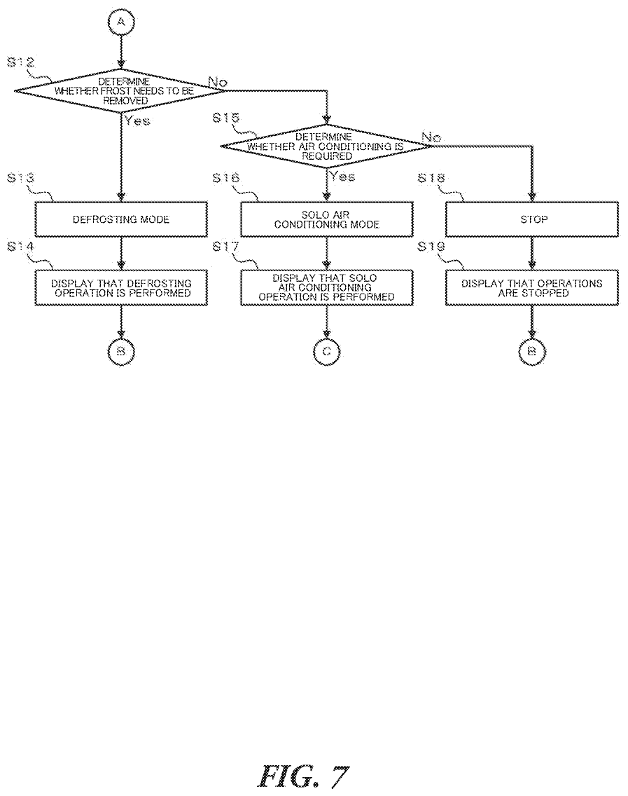

In addition, the controller 40 performs an operation switching control process to start and end the air conditioning operation by using the air conditioning unit 10 and the refrigerant circuit 20, and the battery cooling operation by using the refrigerant circuit 20 and the heat medium circuit 30. The operation of the controller 40 will be described with reference to the flowcharts illustrated in FIGS. 6 and 7.

### <Step S1>

In step S1, the CPU determines, as a charge determination unit, whether the battery B is being charged, or whether the key switch of the vehicle is turned off. When determining that the battery B is being charged, or the key switch of the vehicle is turned off, the CPU moves the step to step S2. On the other hand, when determining that the battery B is not being charged, or the key switch of the vehicle is not turned off, the CPU ends the operation switching control process. Here, the state in which the battery B is being charged or the key switch of the vehicle is turned off means that the vehicle is not driven. In addition, whether the battery B is being charged is determined based on the detected value of the voltage or the current of the electric power supplied to the battery B.

### <Step S2>

When determining that the battery B is being charged or the key switch of the vehicle is turned off in the step S1, the CPU determines, as a battery cooling determination unit, whether the battery B needs to be cooled in the step 2. When determining that the battery B needs to be cooled, the CPU moves the step to step S3. On the other hand, when determining that the battery B does not need to be cooled, the CPU moves the step to step S12. Here, whether the battery B needs to be cooled is determined based on a temperature Tw of the heat medium flowing through the heat medium circuit 30, which is detected by the heat medium temperature sensor 51.

### <Step S3>

When determining that the battery B needs to be cooled in the step S2, the CPU determines, as a defrosting determination unit, whether the frost formed on the outdoor heat exchanger 22 needs to be removed in the step S3. When determining that the frost formed on the outdoor heat exchanger 22 needs to be removed, the CPU moves the step to step S4. On the other hand, when determining that the frost formed on the outdoor heat exchanger 22 does not need to be removed, the CPU moves the step to step S9. Here, whether the frost formed on the outdoor heat exchanger 22 needs to be removed is determined based on the temperature Thex of the refrigerant flowing out of the outdoor heat exchanger 22, which is detected by the refrigerant temperature sensor 47.

### <Step S4>

When determining that the frost formed on the outdoor heat exchanger 22 needs to be removed in the step 3, the CPU determines, as an air conditioning determination unit, whether the air conditioning such as the heating and dehumidifying operation for the vehicle compartment is required in the step 4. When determining that the air conditioning for the vehicle compartment is required, the CPU moves the step to step S5. On the other hand, when determining that the air conditioning for the vehicle compartment is not required, the CPU moves the step to step S10. Here, whether the air conditioning for the vehicle compartment is requited is determined based on the difference between the setting temperature Tset set by the passenger and the temperature Tr detected by the interior air temperature sensor 42, or the humidity Rh detected by the interior air humidity sensor 46.

### <Step S5>

When determining that the air conditioning for the vehicle compartment is required in the step S4, the CPU determines whether the dehumidification for the vehicle compartment is required in the step S5. When determining that the dehumidification for the vehicle compartment is required, the CPU moves the step to step S6. On the other hand, when determining that the dehumidification for the vehicle compartment is not required, the CPU moves the step to step S7.

### <Step S6>

When determining that the dehumidification for the vehicle compartment is required in the step S5, the CPU performs, as a circuit setting unit, the air conditioning operation and the battery cooling operation in a first battery cooling priority mode, which is one of two types of battery cooling priority modes to give priority to the cooling of the battery B over the air conditioning for the vehicle compartment in the step S6. Here, in the first battery cooling priority mode, the fifth solenoid valve 26e is open, and the number of rotations of the compressor 21 is controlled such that the temperature Tw of the heat medium detected by the heat medium temperature sensor 51 is a target heat medium temperature TWO. In addition, in the first battery cooling priority mode, the indoor blower 12 is actuated, and the flowing of the refrigerant through the heat absorbing unit 14 is adjusted by opening and closing the second solenoid valve 26b to control the temperature of the refrigerant in the heat absorbing unit 14. In the first battery cooling priority mode, the second solenoid valve 26b opens the refrigerant flow passage 20e when the temperature Te of the air detected by the cooling air temperature sensor 44 is higher than the target air-blowing temperature TAO by a predetermined temperature γ, and closes the refrigerant flow passage 20e when the temperature Te of the air detected by the cooling air temperature sensor 44 is equal to or lower than a lower limit, for example, 3 degrees Celsius. Moreover, in the first battery cooling priority mode, when determining that the frost formed on the outdoor heat exchanger 22 needs to be removed in the step S3, the CPU, as an outdoor blower restriction unit, restricts the outdoor blower 22d from being actuated until the temperature Thex detected by the refrigerant temperature sensor 47 is higher than a predetermined temperature.

### <Step S7>

When determining that the vehicle compartment does not need to be dehumidified in the step S5, the CPU performs, as the circuit setting unit, the air conditioning operation and the battery cooling operation in a second battery cooling mode, which is one of the two kinds of battery cooling priority modes to give priority to the cooling of the battery B over the air conditioning for the vehicle compartment in the step 7. Here, in the second battery cooling priority mode, the fifth solenoid valve 26e is open, and the number of rotations of the compressor 21 is controlled such that the temperature Tw of the heat medium detected by the heat medium temperature sensor 51 is the target heat medium temperature TWO. In addition, in the second battery cooling priority mode, the indoor blower 12 is actuated and the second solenoid valve 26b is closed. In the second battery cooling priority mode, the dehumidification of the air supplied to the vehicle compartment is not performed, but the heating of the vehicle compartment can be performed by setting the degree of opening of the air mix damper 17 to a value greater than 0% to heat the air flowing through the air flow passage 11 in the heat releasing unit 15 and supplying the heated air to the vehicle compartment. In the second battery cooling priority mode, when the amount of the heat released in the heat releasing unit 15 is not sufficient, the air flowing through the air flow passage 11 is heated by the air heater 16 and supplied to the vehicle compartment. Moreover, in the second battery cooling priority mode, when determining that the frost formed on the outdoor heat exchanger 22 needs to be removed in the step S3, the CPU restricts the outdoor blower 22d from being actuated until the temperature Thex detected by the refrigerant temperature sensor 47 is higher than a predetermined temperature.

### <Step S8>

In step S8, the CPU indicates that the battery cooling priority operation is performed to give priority to the battery cooling operation over the air conditioning operation on the display 53, and moves the step to step S20.

### <Step S9>

When determining that the frost formed on the outdoor heat exchanger 22 does not need to be removed in the step S3, the CPU determines, as an air conditioning determination unit, whether the air conditioning such as the heating and dehumidifying operation for the vehicle compartment is required in step S9. When determining that the air conditioning for the vehicle compartment is required, the CPU moves the step to the step S5. On the other hand, when determining that the air conditioning for the vehicle compartment is not required, the CPU moves the step to step S10. Here, whether the air conditioning for the vehicle compartment is required is determined based on the difference between the setting temperature Tset set by the passenger and the temperature Tr detected by the interior air temperature sensor 42, or the humidity Rh detected by the interior air humidity sensor 46.

### <Step S10>

When determining that the air conditioning for the vehicle compartment is not required in the step S4 or the step S9, the CPU performs the battery cooling operation in a solo battery cooling mode to solely perform the battery cooling operation without the air conditioning operation in the step S10. Here, in the solo battery cooling mode, the CPU controls the number of rotations of the compressor 21 such that the temperature Tw of the heat medium detected by the heat medium temperature sensor 51 is the target heat medium temperature TWO, stops the outdoor blower 12, and the keeps the second solenoid valve 26b closed. In addition, the solo battery cooling mode, when determining that the frost formed on the outdoor heat exchanger 22 needs to be removed in the step S3, the CPU, as the outdoor blower restriction unit, restricts the outdoor blower 22d from being actuated until the temperature Thex detected by the refrigerant temperature sensor 47 is higher than a predetermined temperature.

### <Step S11>

In step S11, the CPU indicates that the solo battery cooling operation is performed to solely perform the battery cooling operation on the display 53, and ends the operation switching control process.

### <Step S12>

When determining that battery B does not need to be cooled in the step S2, the CPU determines, as a defrosting determination unit, whether the frost formed on the outdoor heat exchanger 22 needs to be removed in step S12. When determining that the frost formed on the outdoor heat exchanger 22 needs to be removed, the CPU moves the step to step S13. On the other hand, when determining that the frost formed on the outdoor heat exchanger 22 does not need to be removed, the CPU moves the step to step S15. Here, whether the frost formed on the outdoor heat exchanger 22 needs to be removed is determined based on the temperature Thex of the refrigerant flowing out of the outdoor heat exchanger 22, which is detected by the refrigerant temperature sensor 47.

### <Step S13>

When determining that the frost formed on the outdoor heat exchanger 22 needs to be removed in the step S12, the CPU solely performs the defrosting operation in a defrosting mode in the step S13. Here, in the defrosting mode, the pressure sensor 50 controls the number of rotations of the compressor 21 based on a pressure Pd of the high-pressure side of the refrigerant circuit 20, stops the outdoor blower 12, and keeps the second and fifth solenoid valves closed. In addition, even though the air conditioning for the vehicle compartment is required, the CPU, as an air conditioning restriction unit, solely performs the defrosting operation in the defrosting mode without the air conditioning operation in the step 13. Moreover, in the defrosting mode, when determining that the frost formed on the outdoor heat exchanger 22 needs to be removed in the step S12, the CPU restricts the outdoor blower 22d from being actuated until the temperature Thex detected by the refrigerant temperature sensor 47 is higher than a predetermined temperature.

### <Step S14>

In step S14, the CPU indicates that the defrosting operation is performed on the display 53, and ends the operation switching control process.

### <Step S15>

When determining that the frost formed on the outdoor heat exchanger 22 does not need to be removed in the step S12, the CPU determines, as the air conditioning determination unit, whether the air conditioning for the vehicle compartment is required in step S15. When determining that the air conditioning for the vehicle compartment is required, the CPU moves the step to step S16. On the other hand, when determining that the air conditioning for the vehicle compartment is not required, the CPU moves the step to step S18. Here, whether the air conditioning for the vehicle compartment is requited is determined based on the difference between the setting temperature Tset set by the passenger and the temperature Tr detected by the interior air temperature sensor 42, or the humidity Rh detected by the interior air humidity sensor 46.

### <Step S16>

When determining that the air conditioning for the vehicle compartment is required in the step 15, the CPU performs the air conditioning operation in a solo air conditioning mode to solely perform the air conditioning operation without the battery cooling operation in the step 16. Here, in the solo air conditioning mode, the CPU controls the number of rotations of the compressor 21 such that the temperature Te of the air detected by the cooling air temperature sensor 44 is the target cooling air temperature TEO, and keeps the fifth solenoid valve 26e closed.

### <Step S17>

In step S17, the CPU indicates that the solo air conditioning operation is performed to solely perform the air conditioning operation on the display 53, and moves the step to the step S20.

### <Step S18>

When determining that the air conditioning for the vehicle compartment is not required in the step S15, the CPU stops the air conditioning operation, the battery cooling operation, and the defrosting operation in the step S18, and moves the step to step S19. Here, to stop the air conditioning operation, the battery cooling operation, and the defrosting operation, the CPU stops the outdoor blower 12 and the compressor 21, and closes the second and fifth solenoid valves 26b and 26e.

### <Step S19>

In the step S19, the CPU indicates that the air conditioning operation, the battery cooling operation, and the defrosting operation are stopped on the display 53, and ends the operation switching control process.

### <Step S20>

In the step S20, the CPU determines whether the amount of the heat released in the heat releasing unit 15 is not sufficient. When determining that the amount of the heat released in the heat releasing unit 15 is not sufficient, the CPU moves the step to step S21. On the other hand, when determining that the amount of the heat released from the refrigerant in the heat releasing unit 15 is sufficient, the CPU moves the step to step S22. Here, in the case where the amount of the heat released in the heat releasing unit 15 is not sufficient, a state is kept for a predetermined period of time where the temperature Tc of the air heated in the heat releasing unit 15, which is detected by the heated air temperature sensor 45, is lower than a heated air temperature TCO by a predetermined temperature α.

### <Step S21>

When determining that the amount of the heat released in the heat releasing unit 15 is not sufficient in the step S20, the CPU, as a heat compensation unit, actuates the air heater 16 in the step 21, and ends the operation switching control process.

### <Step S22>

When determining that the amount of the heat released in the heat releasing unit 15 is sufficient in the step S20, the CPU stops the air heater 16 in step S22, and ends the operation switching control process.

As described above, with the present embodiment, the vehicle air conditioning apparatus performs the operation in the first battery cooling mode, the second battery cooling mode, or the solo battery cooling mode, when it is determined that the battery B needs to be cooled and also determined that the frost formed on the outdoor heat exchanger 22 needs to be removed.

By this means, it is possible to cool the battery B and melt the frost formed on the outdoor heat exchanger 22 at the same time by the battery cooling operation, and therefore it is possible to reduce the power consumption compared to the case where the battery cooling operation and the defrosting operation are performed individually.

Meanwhile, the vehicle air conditioning apparatus 1 performs the operation in the first battery cooling priority mode or the second battery cooling priority mode when it is determined that the battery B needs to be cooled, determined that the frost on the heat exchanger 22 needs to be removed, and determined that the temperature or the humidity of the vehicle compartment needs to be adjusted.

By this means, it is possible to perform the cooling of the battery B and the air conditioning for the vehicle compartment at the same time the frost formed on the outdoor heat exchanger 22 is melted by the battery cooling operation and the air conditioning operation. Therefore, it is possible to reduce the power consumption compared to the case where the defrosting operation is performed individually.

In addition, when the amount of the heat released in the heat releasing unit 15 is not sufficient during the air conditioning for the vehicle compartment and the cooling of the battery B, the insufficient amount of the released heat is compensated by the air heater 16.

By this means, it is possible to surely heat the air supplied to the vehicle compartment to a required temperature.

Meanwhile, when it is determined that the dehumidification for the vehicle compartment is not required, the heating operation is performed in the second battery cooling priority mode to heat the vehicle compartment by the heat released from the heat releasing unit 15, or the heat released from the heat releasing unit 15 and the air heater 16.

By this means, it is possible to absorb the heat into the refrigerant in the heat medium heat exchanger 24 without absorbing the heat into the refrigerant in the heat absorbing unit 14, and therefore to surely cool the battery B.

Moreover in the case where it is determined that the battery B does not need to be cooled while the battery B is being charged, and determined that the frost formed on the outdoor heat exchanger 22 needs to be removed and that the temperature of air conditioning or the humidity of the vehicle compartment needs to be adjusted, the vehicle air conditioning apparatus 1 performs the defrosting operation for the outdoor heat exchanger 22 without performing the air conditioning operation as a pre-air conditioning to adjust the temperature and the humidity of the vehicle compartment before the vehicle is driven.

By this means, the defrosting for the outdoor heat exchanger 22 is given priority, and therefore it is possible to surely remove the frost formed on the outdoor heat exchanger 22 before the vehicle is started to drive, and consequently to improve the comfort of the passenger during the driving of the vehicle.

Moreover, the second solenoid valve 26b configured to open and close the refrigerant flow passage 20e and the second expansion valve 25b configured to decompress the refrigerant flowing through the refrigerant flow passage 20e are provided upstream of the heat absorbing unit 14 in the refrigerant flow direction, and the temperature Te of the air cooled in the heat absorbing unit 14 in the first and second battery cooling priority modes is controlled by switching the degree of opening of the second solenoid valve 26b between the full open and the full close.

By this means, it is possible to control the temperature Te of the air cooled in the heat absorbing unit 14 by simply switching the second solenoid valve 26b, and therefore to simplify the control of the temperature Te. Consequently, it is possible to reduce the manufacturing cost.

Moreover, the operation is performed in the first battery cooling priority mode, the second battery cooling priority mode, the solo battery cooling mode, and the defrosting mode while it is determined that the frost formed on the outdoor heat exchanger 22 needs to be removed, the outdoor blower 22d is restricted from being actuated until the temperature Thex detected by the refrigerant temperature sensor 47 is higher than a predetermined temperature.

By this means, it is possible to melt the frost formed on the outdoor heat exchanger 22 for a shorter time than when the outdoor blower 22d is actuated.

In addition, the defrosting operation in the defrosting mode is performed when it is determined that the battery B is being charged or when the key switch of the vehicle is turned off.

By this means, the frost formed on the outdoor heat exchanger 22 is removed when no passenger stays in the vehicle compartment, and therefore it is possible to avoid a case where the temperature and the humidity of the vehicle compartment cannot be adjusted when vehicle with the passenger is driven.

Moreover, the vehicle air conditioning apparatus 1 includes the display 53 configured to provide the information about the defrosting for the outdoor heat exchanger 22, the air conditioning for the vehicle compartment, and the cooling of the battery B.

By this means, it is possible to provide the user with correct information about the operation state of the vehicle air conditioning apparatus 1. Therefore it is possible to prevent the user incorrectly determine that the device is failed.

Here, with the above-described embodiment, in the first battery cooling priority mode, the temperature Te of the air cooled by the heat absorbing unit 14 is controlled by switching between the full open and the full close of the degree of opening of the second solenoid valve 26b provided upstream of the second mechanical expansion valve 25b in the refrigerant flow direction. However, this is by no means limiting. For example, instead of the second mechanical expansion valve 25b and the second solenoid valve 26b, an electronic expansion valve having a variable degree of opening may be provided upstream of the heat absorbing unit 14 in the refrigerant flow direction, and the temperature Te of the air cooled by the heat absorbing unit 14 may be controller by adjusting the degree of opening of the electronic expansion valve in the battery cooling priority mode.

In addition, with the above-described embodiment, in the first battery cooling priority mode, the temperature Te of the air cooled by the heat absorbing unit 14 is controlled by switching the degree of opening of the second solenoid valve 26b between the full open and the full close. However, this is by no means limiting. For example, the temperature Te of the air cooled by the heat absorbing unit 14 may be controlled by switching the degree of opening of the solenoid valve between two different degrees of opening except for the full open and the full close.

Moreover, with the above-described embodiment, the operation states of the air conditioning operation and the battery cooling operation are displayed respectively on the display 53 to provide the passenger with the information about the operation state of each of the air conditioning operation and the battery cooling operation. However, this is by no means limiting. For example, the operation state of each of the air conditioning operation and the battery cooling operation may be informed to the passenger by, for example, a sound from a speaker.

Furthermore, with the above-described embodiment, the battery B is cooled by the refrigerant flowing through the refrigerant circuit 20 via the heat medium flowing through the heat medium circuit 30. However, this is by no means limiting. For example, the battery B may be cooled directly by the refrigerant flowing through the refrigerant circuit 20.

Furthermore, with the above-described embodiment, the air heater 16 is disposed downstream of the heat releasing unit 15 in the refrigerant flow direction in the air flow passage 11, and the air having been heated in the heat releasing unit 15 is heated by the air heater 16. However, this is by no means limiting. The air heater may be disposed upstream of the heat releasing unit 15 in the refrigerant flow direction in the air flow passage 11, and the air which has not been heated in the heat releasing unit 15 may be heated by the air heater 16.

### REFERENCE SIGNS LIST

1 vehicle air conditioning apparatus
11 air flow passage
14 heat absorbing unit
15 heat releasing unit
16 air heater
20 refrigerant circuit
21 compressor
22 outdoor heat exchanger
22d outdoor blower
24 heat medium heat exchanger
25b second expansion valve
25c third expansion valve
26b second solenoid valve
26e fifth solenoid valve
30 heat medium circuit
40 controller
47 refrigerant temperature sensor
53 display
B battery

1. A vehicle air conditioning apparatus with a battery cooling function to cool a battery for supplying electronic power to an electric motor for driving a vehicle, the vehicle air conditioning apparatus comprising:
a compressor configured to compress a refrigerant;
a battery cooling heat absorbing unit configured to absorb heat released from the battery;
an outdoor heat exchanger configured to perform a heat exchange between the refrigerant and air outside a vehicle compartment;
a battery cooling circuit configured to release the heat from the refrigerant discharged from the compressor in the outdoor heat exchanger, and absorb the heat into the refrigerant in the battery cooling heat absorbing unit;
a defrosting circuit configured to release the heat from the refrigerant discharged from the compressor in the outdoor heat exchanger, and cause the refrigerant flowing out of the outdoor heat exchanger to be sucked into the compressor;
a battery cooling determination unit configured to determine whether the battery needs to be cooled;
a defrosting determination unit configured to determine whether frost formed on the outdoor heat exchanger needs to be removed; and
a circuit setting unit configured to flow the refrigerant discharged from the compressor through the battery cooling circuit, when the battery cooling determination unit determines that the battery needs to be cooled, and the defrosting determination unit determines that the frost formed on the outdoor heat exchanger needs to be removed.

2. The vehicle air conditioning apparatus according to claim 1, further comprising:
an indoor heat exchanger configured to perform a heat exchange between the air supplied to the vehicle compartment and the refrigerant;
a battery cooling air conditioning circuit configured to release the heat from the refrigerant discharged from the compressor in the outdoor heat exchanger, absorb the heat into the refrigerant in the battery cooling heat absorbing unit, and release the heat from the refrigerant or absorb the heat into the refrigerant in the indoor heat exchanger; and
an air conditioning determination unit configured to determine whether a temperature or a humidity of the vehicle compartment needs to be adjusted,
wherein the circuit setting unit flows the refrigerant discharged from the compressor through the battery cooling air conditioning circuit, when the battery cooling determination unit determines that the battery needs to be cooled; the defrosting determination unit determines that the frost formed on the outdoor heat exchanger needs to be removed; and the air conditioning determination unit determines that the temperature or the humidity of the vehicle compartment needs to be adjusted.

3. The vehicle air conditioning apparatus according to claim 2, further comprising:
an air heater configured to heat the air supplied to the vehicle compartment; and
a heat compensation unit configured to compensate an insufficient amount of the heat by the air heater, when an amount of the heat released in the indoor heat exchanger is not sufficient while air conditioning for the vehicle compartment and cooling of the battery are performed by the battery cooling air conditioning circuit.

4. The vehicle air conditioning apparatus according to claim 3, further comprising:
a heat releasing unit as an indoor heat exchanger connected in series with the outdoor heat exchanger in the battery cooling circuit,
wherein when the air conditioning determination unit determines that the vehicle compartment does not need to be dehumidified, a heating operation for the vehicle compartment is performed in the battery cooling circuit by using the heat released from the heat releasing unit, or the heat released from the heat releasing unit and the air heater.

5. The vehicle air conditioning apparatus according to claim 2, further comprising:
a charge determination unit configured to determine whether the battery is being charged; and
an air conditioning restriction unit configured to perform a defrosting operation to remove the frost formed on the outdoor heat exchanger by using the defrosting circuit without adjusting the temperature or the humidity of the vehicle compartment, while the charge determination unit determines that the battery is being charged, when the battery cooling determinant unit determines that the battery does not need to be cooled; when the defrosting determination unit determines that the frost formed on the outdoor heat exchanger needs to be removed; and when the air conditioning determination unit determines that the temperature or the humidity of the vehicle compartment needs to be adjusted.

6. The vehicle air conditioning apparatus according to claim 2, wherein:
a flow passage opening and closing valve configured to open and close a refrigerant flow passage, and an expansion valve configured to decompress the refrigerant are provided upstream of a heat absorbing unit as an indoor heat exchanger in a refrigerant flow direction; and
when the refrigerant discharged from the compressor is flowed through the battery cooling air conditioning circuit, the temperature of the battery which is cooled by the battery cooling heat absorbing unit is controlled by adjusting the number of rotations of the compressor, and the temperature of the air which is cooled in the heat absorbing unit is controlled by switching a degree of opening of the flow passage opening and closing valve between full open and full close.

7. The vehicle air conditioning apparatus according to claim 2, wherein:
a flow passage opening and closing valve configured to open and close a refrigerant flow passage, and an expansion valve configured to decompress the refrigerant are provided upstream of the heat absorbing unit as an indoor heat exchanger in a refrigerant flow direction; and
when the refrigerant discharged from the compressor is flowed through the battery cooling air conditioning circuit, the temperature of the battery which is cooled by the battery cooling heat absorbing unit is controlled by adjusting the number of rotations of the compressor, and the temperature of the air which is cooled in the heat absorbing unit is controlled by switching a degree of opening of the flow passage opening and closing valve between two different degrees of opening.

8. The vehicle air conditioning apparatus according to claim 1, further comprising:
an outdoor blower configured to flow the air subjected to a heat exchange with the refrigerant in the outdoor heat exchanger;
a refrigerant temperature sensor configured to detect a temperature of the refrigerant flowing out of the outdoor heat exchange; and
an outdoor blower restriction unit configured to restrict the outdoor blower from being actuated until the temperature detected by the refrigerant temperature sensor is higher than a predetermined temperature, when the refrigerant discharged from the compressor is flowed through the battery cooling circuit, the defrosting circuit, or the battery cooling air conditioning circuit while the defrosting determination unit determines that the frost formed on the outdoor heat exchanger needs to be removed.

9. The vehicle air conditioning apparatus according to claim 1, wherein the removing of the frost formed on the outdoor heat exchanger is performed by the defrosting circuit, when the charge determination unit determines that the battery is being charged, or when a key switch of the vehicle is turned off.

10. The vehicle air conditioning apparatus according to claim 2, further comprising an information unit configured to provide information about the removing of the frost formed on the outdoor heat exchanger, air conditioning for the vehicle compartment, and the cooling of the battery.

11. The vehicle air conditioning apparatus according to claim 4, further comprising:
a charge determination unit configured to determine whether the battery is being charged; and
an air conditioning restriction unit configured to perform a defrosting operation to remove the frost formed on the outdoor heat exchanger by using the defrosting circuit without adjusting the temperature or the humidity of the vehicle compartment, while the charge determination unit determines that the battery is being charged, when the battery cooling determinant unit determines that the battery does not need to be cooled; when the defrosting determination unit determines that the frost formed on the outdoor heat exchanger needs to be removed; and when the air conditioning determination unit determines that the temperature or the humidity of the vehicle compartment needs to be adjusted.

12. The vehicle air conditioning apparatus according to claim 5, wherein:
a flow passage opening and closing valve configured to open and close a refrigerant flow passage, and an expansion valve configured to decompress the refrigerant are provided upstream of a heat absorbing unit as an indoor heat exchanger in a refrigerant flow direction; and
when the refrigerant discharged from the compressor is flowed through the battery cooling air conditioning circuit, the temperature of the battery which is cooled by the battery cooling heat absorbing unit is controlled by adjusting the number of rotations of the compressor, and the temperature of the air which is cooled in the heat absorbing unit is controlled by switching a degree of opening of the flow passage opening and closing valve between full open and full close.

13. The vehicle air conditioning apparatus according to claim 5, wherein:
a flow passage opening and closing valve configured to open and close a refrigerant flow passage, and an expansion valve configured to decompress the refrigerant are provided upstream of the heat absorbing unit as an indoor heat exchanger in a refrigerant flow direction; and
when the refrigerant discharged from the compressor is flowed through the battery cooling air conditioning circuit, the temperature of the battery which is cooled by the battery cooling heat absorbing unit is controlled by adjusting the number of rotations of the compressor, and the temperature of the air which is cooled in the heat absorbing unit is controlled by switching a degree of opening of the flow passage opening and closing valve between two different degrees of opening.

14. The vehicle air conditioning apparatus according to claim 4, further comprising:
an outdoor blower configured to flow the air subjected to a heat exchange with the refrigerant in the outdoor heat exchanger;
a refrigerant temperature sensor configured to detect a temperature of the refrigerant flowing out of the outdoor heat exchange; and
an outdoor blower restriction unit configured to restrict the outdoor blower from being actuated until the temperature detected by the refrigerant temperature sensor is higher than a predetermined temperature, when the refrigerant discharged from the compressor is flowed through the battery cooling circuit, the defrosting circuit, or the battery cooling air conditioning circuit while the defrosting determination unit determines that the frost formed on the outdoor heat exchanger needs to be removed.

15. The vehicle air conditioning apparatus according to claim 7, further comprising:
an outdoor blower configured to flow the air subjected to a heat exchange with the refrigerant in the outdoor heat exchanger;
a refrigerant temperature sensor configured to detect a temperature of the refrigerant flowing out of the outdoor heat exchange; and
an outdoor blower restriction unit configured to restrict the outdoor blower from being actuated until the temperature detected by the refrigerant temperature sensor is higher than a predetermined temperature, when the refrigerant discharged from the compressor is flowed through the battery cooling circuit, the defrosting circuit, or the battery cooling air conditioning circuit while the defrosting determination unit determines that the frost formed on the outdoor heat exchanger needs to be removed.

16. The vehicle air conditioning apparatus according to claim 6, wherein the removing of the frost formed on the outdoor heat exchanger is performed by the defrosting circuit, when the charge determination unit determines that the battery is being charged, or when a key switch of the vehicle is turned off.

17. The vehicle air conditioning apparatus according to claim 8, wherein the removing of the frost formed on the outdoor heat exchanger is performed by the defrosting circuit, when the charge determination unit determines that the battery is being charged, or when a key switch of the vehicle is turned off.

18. The vehicle air conditioning apparatus according to claim 4, further comprising an information unit configured to provide information about the removing of the frost formed on the outdoor heat exchanger, air conditioning for the vehicle compartment, and the cooling of the battery.

19. The vehicle air conditioning apparatus according to claim 6, further comprising an information unit configured to provide information about the removing of the frost formed on the outdoor heat exchanger, air conditioning for the vehicle compartment, and the cooling of the battery.

20. The vehicle air conditioning apparatus according to claim 9, further comprising an information unit configured to provide information about the removing of the frost formed on the outdoor heat exchanger, air conditioning for the vehicle compartment, and the cooling of the battery.
